(19) United States
(12) Patent Application Publication
(10) Pub. No.: US 2019/0215658 A1
(43) Pub. Date: Jul. 11, 2019

(54) Process and system for utilizing GPS technology to navigate inside theme parks and zoos

(71) Applicant: Chad Burr, Jackson, AL (US)

(72) Inventor: Chad Burr, Jackson, AL (US)

(21) Appl. No.: 15/866,004

(22) Filed: Jan. 9, 2018

(51) Int. Cl. H04W 4/024; H04W 4/021; G06F 17/30; H04L 29/08

(52) U.S. Cl. CPC H04W 4/024; H04L 67/306; G06F 17/30241; H04W 4/021

(57) ABSTRACT

The current invention is system and application that lets a user search the theme park of their choice and download a map that can be browsed both on and offline. The application will have functions that allow a user in advance by knowing where to park their car and what eating facilities are available. The application will allow a user to find the closest attractions in their area using of GPS technology and allow a user to navigate various destinations (i.e. rides, restrooms, restaurants, etc.) inside the park using GPS technology. The system would work like a smartphone application.

### CROSS-REFERENCES TO RELATED APPLICATIONS (IF ANY)

None

### BACKGROUND

### 1. Field of the Invention

The present invention relates to a process learn more about and locate theme parks.

### 2. Description of Prior Art

That is a total of nearly 252 million visitors to these 4 main theme park companies around the United States. Anyone who has spent time in Theme Parks knows that the paper maps handed out at the front gate aren't not easy to use and follow. Anyone who has been to a Theme Park knows that Restrooms aren't the easiest places to find especially in a hurry.

Currently, there are no applications on the market that allow a user not to get lost when someone is wandering around a theme park or zoo. They can walk about in endless circles trying to find a washroom, a ride or the closest place to eat. Wouldn't it be great to have a map of America's most popular theme parks and attractions in your pocket? There is still room for improvement in the art.

### SUMMARY OF THE INVENTION

The current invention is system and application that lets a user search the theme park of their choice and download a map that can be browsed both on and offline. The application will have functions that help a user in advance by knowing where to park their car, where the attraction are and what eating facilities are available. The application will allow a user to navigate various destinations (i.e. rides, restrooms, restaurants, etc.) inside the park using GPS technology. The application will also allow a user to find the closest attractions in their area.

The system, in the preferred embodiment, would work like a smartphone application, this product would be available through the respective marketplace for smartphones.

The current invention has other options such as ride wait time information, links to YouTube videos of each ride in the park (if available), Park Show time information for musical/theatrical productions, water shows, etc. and informational notices that provide things like park hours, special events, discounts and other specials going on in various shops at the park, and other general information that would be of interest to visitors.

Emergency information could also be given through the app. For lost children or other emergencies, the application could be a great means of spreading information quickly across the park.

In the application, a user can mark where they parked their car. This is always a plus after a long day at a theme park.

The system will give users opportunities to earn discounts or redeem park points. For example, the park could put out a notice that if someone purchases a Roller Coaster photo on a certain ride, they would get 25% off of a food purchase at a participating vendor in the park or, for every dollar they spend through the app, they would get points towards a discounted ticket on their next visit.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen; and

FIG. 3 shows a sample of a profile screen;

FIG. 4 shows a sample settings screen;

FIG. 5 shows a sample home page;

FIG. 6 shows a sample parks list page;

FIG. 7 shows the select park function;

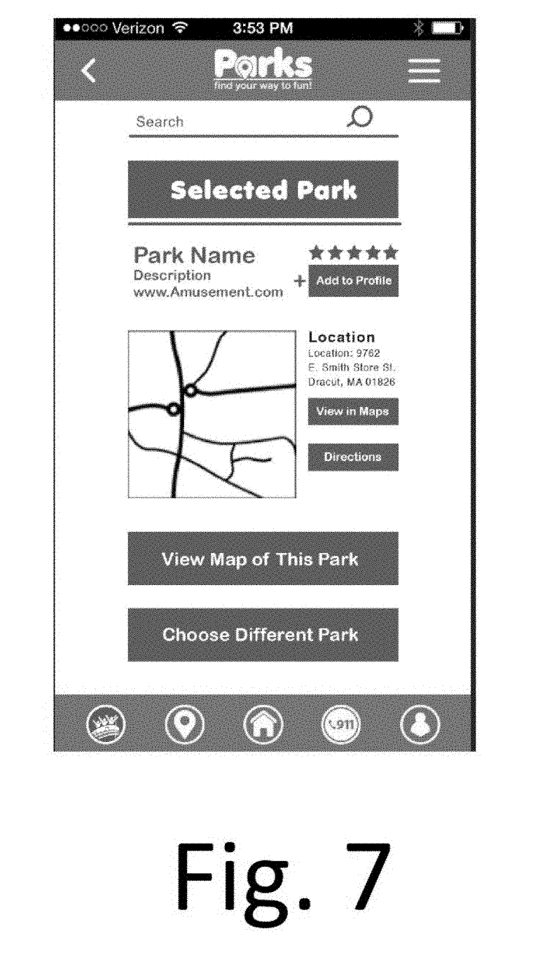

FIG. 8 shows a park map function;

FIG. 9 shows a park ride map;

FIG. 10 shows a ride information screen; and

FIG. 11 shows a block diagram of the system and application.

### DESCRIPTION OF THE PREFERRED EMBODIMENT

There are a number of significant design features and improvements incorporated within the invention.

The current invention is a system and application 1 that would allow a user to search the theme park of their choice and download a map that can be browsed both on and offline. The application will have functions to assist a user in advance by knowing where to park their car, where the attraction are and what eating facilities are available. The application will allow a user to destinations inside the park using of GPS technology.

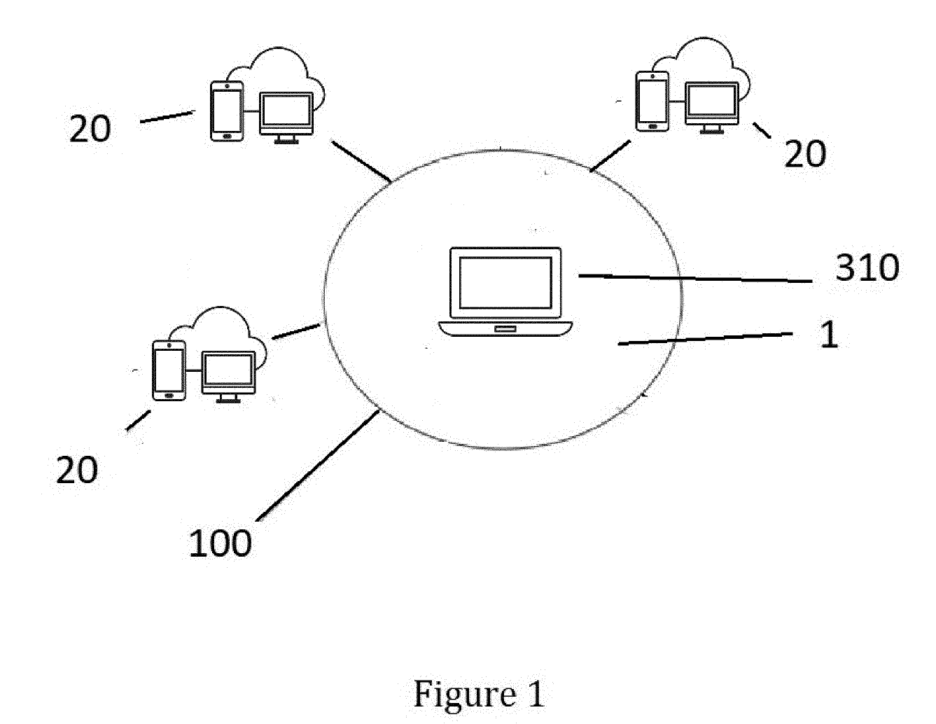

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 10 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

Brief Overview

This current invention is a system 1 and application is aimed to give users information and maps about theme parks and allow users to navigate to various destinations inside theme parks. The system 1 will include each user feature separate from the other or combined.

The system and application 1 lets a user search the theme park of their choice and download a map that can be browsed both on and offline. Users can prepare their journey in advance by knowing where to park their car, where the attraction are and what eating facilities are available. The system 1 uses GPS technology. The users will automatically get access to the top places to visit that are closest to them. They can save their favorite parks and select from a list of parks and attractions.

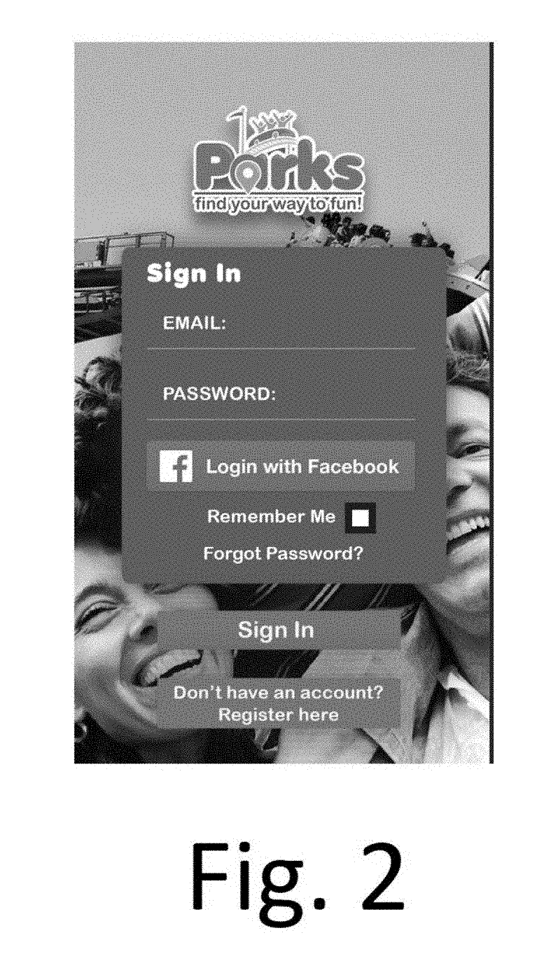

The users would sign-in directly or using social logins as shown in FIG. 2 with the user registering the app,

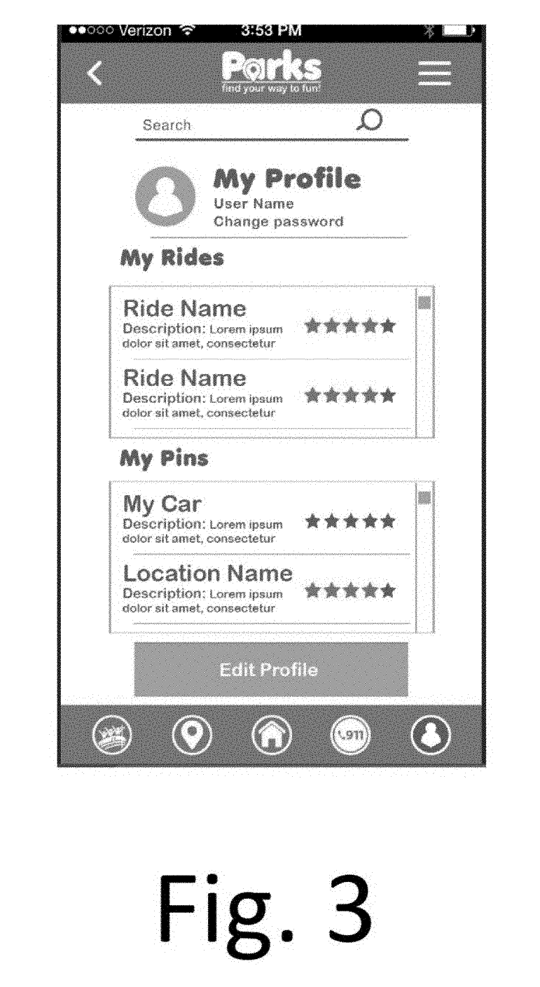

The user will set up their profile for the system using the profile screen as shown in FIG. 3. This would allow the user to set up their personal information and information about their favorite theme parks and rides.

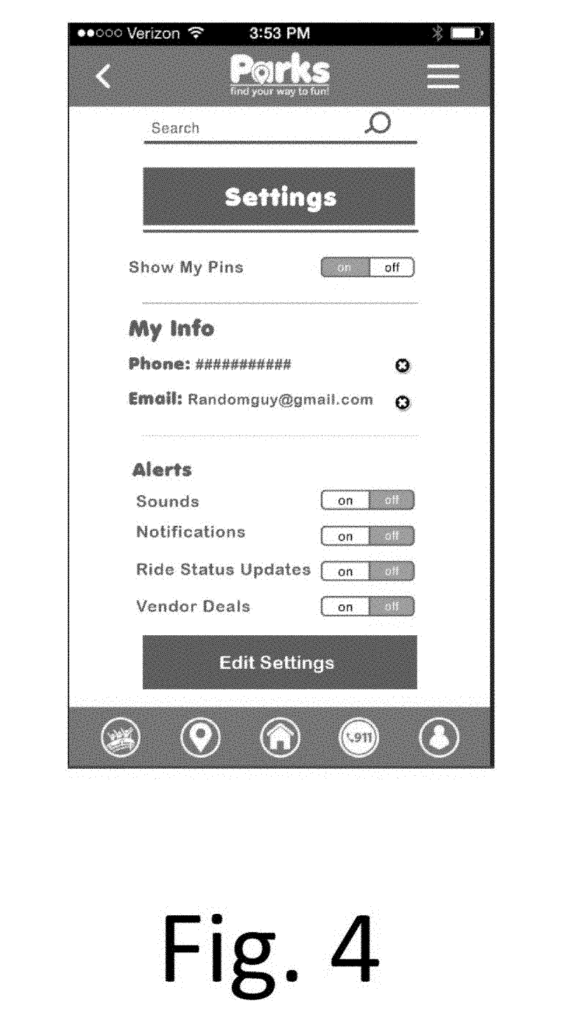

The system 1 has a setting screen which allows a user to set up the system 1 to which rides information and notifications they want, the sounds they want, the offers that they want and ride updates as shown in FIG. 4.

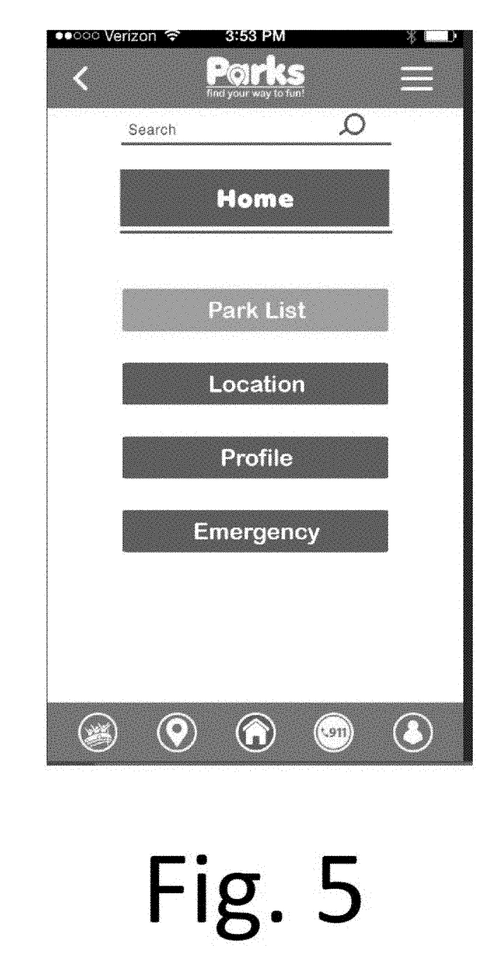

The system 1 will have a home page as shown in FIG. 5. The home page will connect the user to the functions and options of the system such as parks list, profile, emergency and location.

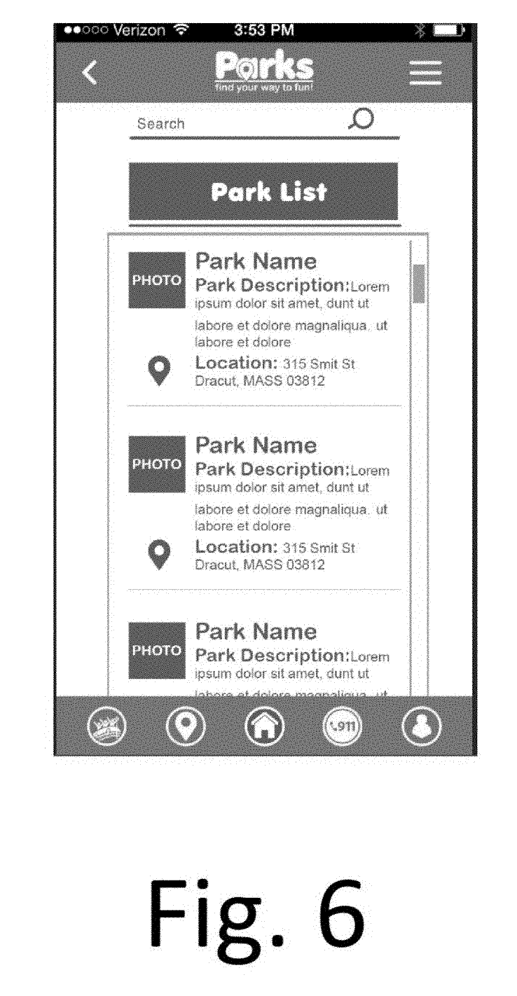

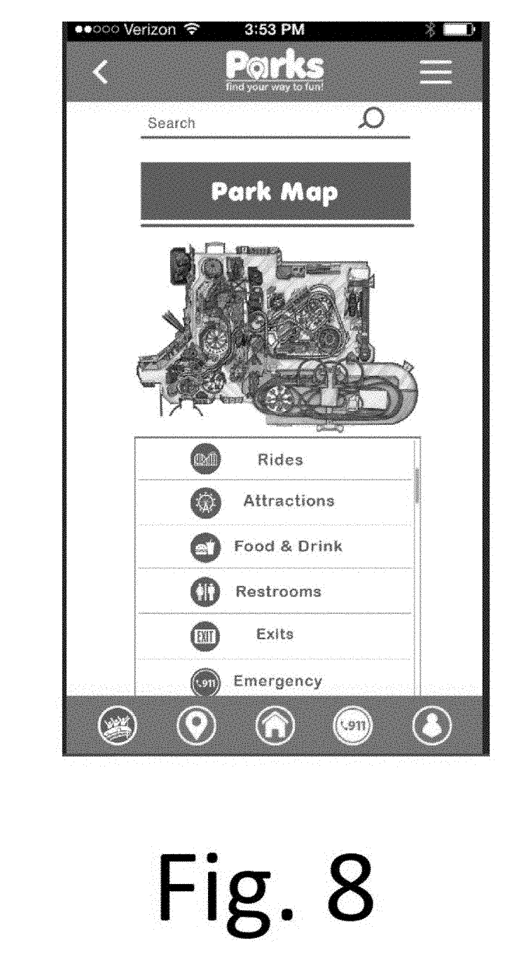

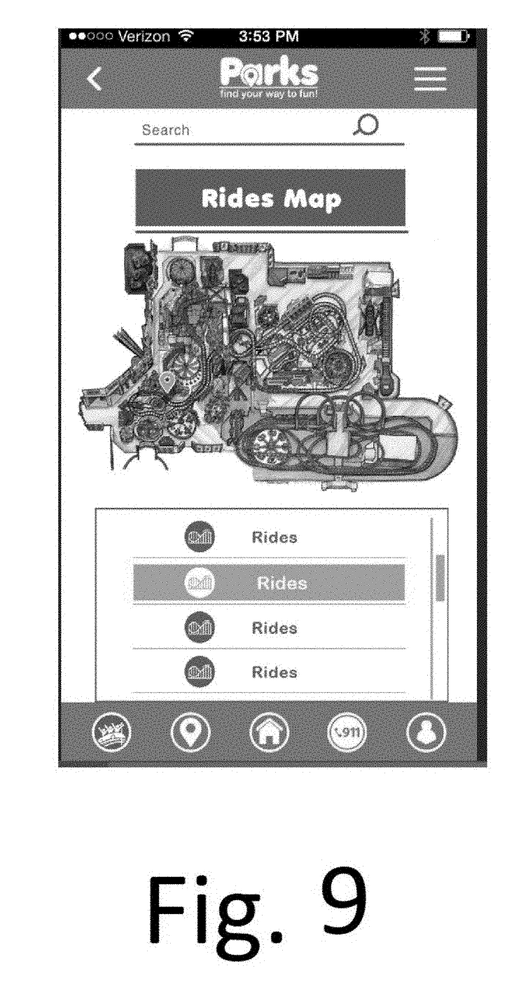

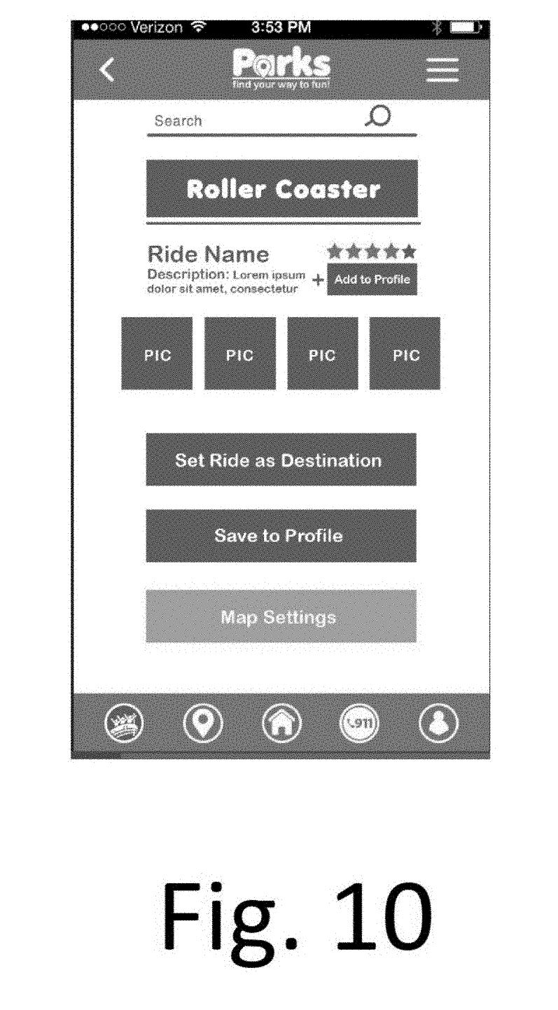

The parks list function is shown in FIG. 6 and it shows a list of the parks, their name and information about the park such as location and rides. When a user selects a park a select park screen come up with information about the park and an option to show a map of the park which is shown in FIG. 8. A map that shows the rides of the park can be view as well as shown in FIG. 9. This map shows the user how to get to each ride by giving turn by turn walking directions using GPS Technology. The user may also choose a ride information screen which gives information, previews and comments about each individual ride, along with setting that ride as a Destination (FIG. 10).

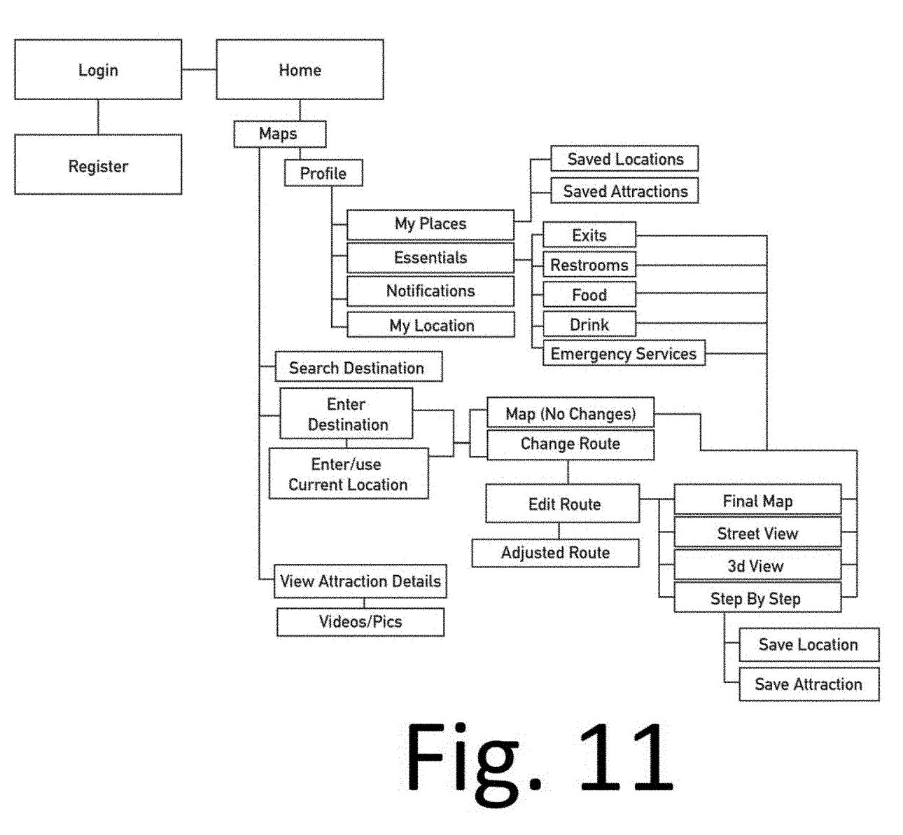

FIG. 11 shows a block diagram of the system and application and its functions.

The current invention will have other options such as ride wait time information, links to YouTube videos of each ride in the park (if available), Park Show time information for musical/theatrical productions, water shows, etc. and informational notices that provide things like park hours, special events, discounts and other specials going on in various shops at the park, and other general information that would be of interest to visitors.

The Emergency information function would be given through the system 1. For lost children or other emergencies, the system 1 could be a great source and means of spreading information quickly across the park.

Using the application a user can mark on a map where they parked their car in the system 1 so that they can find it when they want to leave. This is always a plus after a long day at a theme park.

The system 1 will give users opportunities to earn discounts or redeem park points. For example, the park could put out a notice that if someone purchases a Roller Coaster photo on a certain ride, they would get 25% off of a food purchase at a participating vendor in the park or for every dollar they spend through the app, they would get points towards a discounted ticket on their next visit.

Advantages

Not only will this mobile app be much more clearer with the park layout, but it will also cut down significantly on the number of paper maps that get handed out on a daily basis. The system has GPS Technology and relies on Google maps for the most updated details. It is practical saving time walking around lost and get the most out of a trip, it provides fun. The current invention allows a user to find out about the best tourist attractions and theme parks near them while being interactive with customer reviews and leave feedback based on their experience

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system comprising;
having a system that resides in the non-transitory memory of a computing device;
providing and displaying information about a plurality of theme parks based on location and preference, allowing a user to select a theme park and providing maps and information for that theme park,
allowing the user to set up their personal information,
allowing the user to set up information about their favorite theme parks and rides,
having a settings screen which allows the user to set up the system to which rides information and notifications they receive,
having a navigable park map that can be browsed both on and offline, having park show time information;
having information about the rides in the theme park where such information includes one or more of a set of wait time, ride location, previews, links to videos of the ride and comments about the ride,
setting a ride as a destination with directions on the map, and
showing the location of a user's vehicle with directions on the map.

2. A system according to claim 1 having a login screen.

3. A system according to claim 1 having the users set up profiles with .

4. (canceled)

5. (canceled)

6. (canceled)

7. A system according to claim 1 offering discount coupons for the theme park.

8. A system according to claim 5 having an emergency function.

9. A system according to claim 1 using a GPS system.

10. A system according to claim 1 providing each feature either separately or combined.

11. A system according to claim 3 the user to set up their personal information and information about a plurality of theme parks and rides.
